(19) United States
(12) Patent Application Publication
(10) Pub. No.: US 2015/0178649 A1
(43) Pub. Date: Jun. 25, 2015

(54) Intelligent and Interactive System For Routing and Scheduling

(71) Applicants: Kevin C. Furman, Morristown, NJ (US); Vikas Goel, Houston, TX (US); Joshua R. Lowry, Spring, TX (US); Yufen Shao, Houston, TX (US)

(72) Inventors: Kevin C. Furman, Morristown, NJ (US); Vikas Goel, Houston, TX (US); Joshua R. Lowry, Spring, TX (US); Yufen Shao, Houston, TX (US)

(21) Appl. No.: 14/550,458

(22) Filed: Nov. 21, 2014

Related U.S. Application Data
(60) Provisional application No. 61/919,426, filed on Dec. 20, 2013.

(51) Int. Cl. G06Q 10/06

(52) U.S. Cl. CPC G06Q 10/06312

(57) ABSTRACT

A system, including: a memory that stores computer executable instructions; and processing circuitry that executes the instructions in order to, generate a graphical user interface, which includes an intelligent Gantt chart that displays a working schedule of a task assigned to a resource, receive a command to change the working schedule, integrate the change into the working schedule, and update and display a performance metric based on the change.

### CROSS-REFERENCE TO RELATED APPLICATION

This application claims the benefit of U.S. Provisional Patent Application 61/919,426 filed Dec. 20, 2013 entitled INTELLIGENT AND INTERACTIVE SYSTEM FOR ROUTING AND SCHEDULING, the entirety of which is incorporated by reference herein.

### FIELD OF THE INVENTION

Disclosed aspects and methodologies relate to an interactive and intelligent scheduling interface, and more particularly to planning and operations of an LNG project.

### BACKGROUND

This section is intended to introduce various aspects of the art, which may be associated with aspects of the disclosed techniques and methodologies. This discussion is believed to assist in providing a framework to facilitate a better understanding of particular aspects of the disclosure. Accordingly, this section should be read in this light and not necessarily as admissions of prior art.

In large-scale combined vehicle routing, scheduling and inventory management optimization and logistics problems, building, visualizing and manipulating a schedule through a manual interface, such as a conventional Gantt Chart, can be quite cumbersome, tedious, and time consuming A conventional Gantt chart can be a type of bar chart, generated in a spreadsheet program, which illustrates a project schedule.

The project schedule can include tasks assigned to be completed by a particular resource, such as a vehicle to transport items from one location to another. If a task that needs to be rescheduled is affected by or dependent on the particular vehicle to which it is initially assigned, then this vehicle dependence can pose a challenge to customizing attributes of the task when reassigning the task to a different vehicle. For example, if the task requires a vehicle to travel, and different vehicles travel at different speeds, then the time duration of a task is dependent on the vehicle. Further, there may be additional constraints in the problem outside of the time schedule that cannot be visualized on a conventional Gantt chart. Examples of such constraints that cannot be visualized on a conventional Gantt chart include, but are not limited to, inventory capacity constraints for the transported material or loading dock/berth utilization limits.

There is existing software using Gantt charts (for example by vendors such as Actenum and IBM).

### SUMMARY

A system, including: a memory that stores computer executable instructions; and processing circuitry that executes the instructions in order to, generate a graphical user interface, which includes an intelligent Gantt chart that displays a working schedule of a task assigned to a resource, receive a command to change the working schedule, integrate the change into the working schedule, and update and display a performance metric based on the change.

A method, including: generating a graphical user interface including an interactive Gantt chart; selecting a task to be scheduled from a set of options provided through the graphical user interface; adding a visual representation of the task to the interactive Gantt chart and assigning the task to a first vehicle or vessel; and moving, on the interactive Gantt chart, the visual representation of the task from a first location in the interactive Gantt chart to a second location in the interactive Gantt chart, wherein the moving is in response to user interaction with a computer input device.

A non-transitory computer readable medium encoded with instructions, which when executed by a computer causes the computer to execute a method including: generating a graphical user interface including an interactive Gantt chart; selecting a task to be scheduled from a set of options provided through the graphical user interface; adding a visual representation of the task to the interactive Gantt chart and assigning the task to a first vehicle or vessel; and moving, on the interactive Gantt chart, the visual representation of the task from a first location in the interactive Gantt chart to a second location in the interactive Gantt chart, wherein the moving is in response to user interaction with a computer input device.

### BRIEF DESCRIPTION OF THE DRAWINGS

While the present disclosure is susceptible to various modifications and alternative forms, specific examples thereof have been shown in the drawings and are herein described in detail. It should be understood, however, that the description herein of specific examples is not intended to limit the disclosure to the particular forms disclosed herein, but on the contrary, this disclosure is to cover all modifications and equivalents as defined by the appended claims. It should also be understood that the drawings are not necessarily to scale, emphasis instead being placed upon clearly illustrating principles of the present technological advancement. Moreover, certain dimensions may be exaggerated to help visually convey such principles.

FIG. 1 illustrates exemplary components of a vehicle/vessel routing and scheduling application.

FIG. 2 illustrates an example of an interactive Gantt interface.

FIGS. 3A, 3B, and 3C illustrate an example of an animation in the interactive Gantt interface.

FIG. 4 illustrates an exemplary method of using the interactive Gantt interface.

FIG. 5 illustrates an exemplary method for altering a working schedule using the vehicle/vessel routing and scheduling application.

FIG. 6 illustrates an example of a computer system.

### DETAILED DESCRIPTION

Non-limiting examples of the present technological advancement are described herein. The invention is not limited to the specific examples described below, but rather, it includes all alternatives, modifications, and equivalents falling within the true spirit and scope of the appended claims.

Various terms as used herein are defined below. To the extent a term used in a claim is not defined below, it should be given the broadest possible definition persons in the pertinent art have given that term as reflected in at least one printed publication or issued patent.

As used herein, “and/or” placed between a first entity and a second entity means one of (1) the first entity, (2) the second entity, and (3) the first entity and the second entity. Multiple elements listed with “and/or” should be construed in the same fashion, i.e., “one or more” of the elements so conjoined.

As used herein, “exemplary” is used exclusively herein to mean “serving as an example, instance, or illustration.” Any aspect described herein as “exemplary” is not necessarily to be construed as preferred or advantageous over other aspects.

As used herein, “hydrocarbon” includes any of the following: oil (often referred to as petroleum), natural gas in any form including liquefied natural gas (LNG), gas condensate, tar and bitumen.

As used herein, “hydrocarbon management” or “managing hydrocarbons” includes hydrocarbon extraction, hydrocarbon production, hydrocarbon exploration, identifying potential hydrocarbon resources, identifying well locations, determining well injection and/or extraction rates, identifying reservoir connectivity, acquiring, disposing of and/or abandoning hydrocarbon resources, reviewing prior hydrocarbon management decisions, and any other hydrocarbon-related acts or activities.

As used herein, “vehicle” means any ship, barge, plane, train, truck, or other mechanical means of transportation.

As used herein, “vessel” means any ship, barge, or other water faring vehicle.

“optimal,” “optimizing,” “optimize,” “optimality,” “optimization” (as well as derivatives and other forms of those terms and linguistically related words and phrases), as used herein, are not intended to be limiting in the sense of requiring the present invention to find the best solution or to make the best decision. Although a mathematically optimal solution may in fact arrive at the best of all mathematically available possibilities, real-world embodiments of optimization routines, methods, models, and processes may work towards such a goal without ever actually achieving perfection. Accordingly, one of ordinary skill in the art having benefit of the present disclosure will appreciate that these terms, in the context of the scope of the present invention, are more general. The terms can describe working towards a solution which may be the best available solution, a preferred solution, or a solution that offers a specific benefit within a range of constraints; or continually improving; or refining; or searching for a high point or a maximum for an objective; or processing to reduce a penalty function.

With the development of advanced mathematical optimization models for vessel routing and scheduling (see, for example, international patent application no. PCT/US2012/065310, filed Nov. 15, 2012, the entire contents of which are hereby incorporated by reference), the need for an intuitive and easy to use interface for a software system is necessary. Further, to allow for manual generation of a vessel routing schedule or manual modification of an existing schedule, given that there are a large number of variables and constraints on such a schedule (thousands, tens of thousands, hundreds of thousands or millions), there is a need for an advanced system to allow for manipulation of the schedule with visual feedback to see the effects, and further to notify a user on potential impact of changes when various interacting restrictions or constraints are violated.

The concept of a “schedule” is data being displayed, input, output, manipulated, updated and/or modified by the various components of the system above. At the simplest level, a schedule may consist of a number of tasks along with the associated data for the tasks. Data associated with tasks can include time when the task begins, time when the task ends, the amount of time the task spends in its various activities (loading, traveling from A to B, unloading, etc.), a specification of the vehicle, vessel, processing unit or other entity performing the task, and for tasks where a vehicle/vessel travels, the locations visited by the vehicle/vessel and the order of the locations.

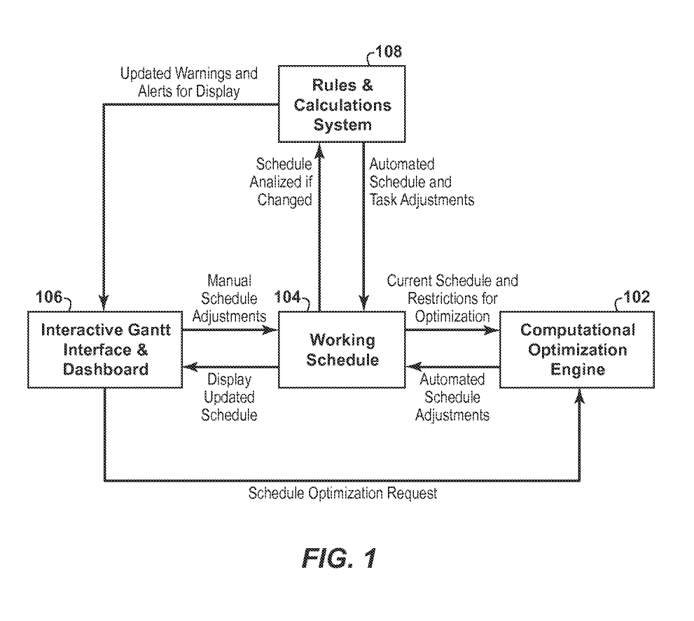

FIG. 1 illustrates exemplary components of a vehicle/vessel routing and scheduling application with several interacting components in the boxes, and the actions taken by the components described along the arrows. The vehicle/vessel routing and scheduling application can include computational optimization engine 102, working schedule 104, interactive Gantt interface 106, and rules and calculations system 108.

Computational Optimization Engine

An example of the computational optimization engine 102 is found, for example, in international patent application no. PCT/US2012/065310, the entire content of which is hereby incorporated by reference. As described in this patent application, the computational optimization engine can generate an optimized vessel schedule. The optimization engine of PCT/US2012/065310 in the context of shipping LNG (liquid natural gas). However, the present technological advancement is applicable to a much wider range of vehicle or vessel routing and scheduling, and particularly refinery and chemical plant raw materials, intermediate and final products (e.g. crude oil, condensate, VGO, condensate, diesel, gasoline, lubricants, basic chemicals, etc.). Thus, the present technological invention could also be used in combination with the system for bulk product routing and scheduling described in U.S. patent application Ser. No. 11/802,616 as the computational optimization engine 102. U.S. patent application Ser. No. 11/802,616 is hereby incorporated by reference in its entirety.

As described in PCT/US2012/065310, given a set of input data regarding a shipping supply chain and requirements for delivery of some product, an optimization model or models can be used in conjunction with solution algorithms (i.e. incorporated into a computational engine) to derive a schedule for all the vessels such that all constraints are satisfied (if possible) with details regarding the timing of when vessels perform various actions, the locations these actions occur, and the amount of material loaded and unloaded when those actions occur. Some of the variables of such model(s) can be mapped to the definition of tasks for scheduling used here.

In a conventional scheduling system, a task is defined as a single action or activity, and the pre-defined time required for that activity. The present technological advancement defines task differently. A task, for a vessel or vehicle as used in the present technological advancement, is the locations to and from that the vessel or vehicle is traveling and the cumulative time for loading, unloading, multiple travel-legs, and waiting or idle time for the vessel or vehicle. This task used in the interactive Gantt chart 106 is the smallest element of a vessel schedule that captures enough information to evaluate effect on contractual obligations, inventory constraints, berth limits, etc. This provides clear and concise methods for displaying tightly coupled tasks.

It should be noted that the computational optimization engine 102 is not limited to those described in in PCT/US2012/065310 or U.S. Ser. No. 11/802,616. There are many potential alternatives for schedule optimization models and solution methods. However, these particular two examples would be useful if applying this invention to LNG vessel scheduling and inventory management, or LNG supply chain analysis. One skilled in the art would be able to identify suitable alternatives for schedule optimization models and solution methods (i.e. computational engines) for the particular scheduling application for which to apply the present technological advancement.

Working Schedule

The working schedule 104 may be an initial schedule generated manually by a person or an earlier optimized schedule. The working schedule 104 can communicate to the computational optimization engine 102 the current schedule and restrictions for optimization. Such restrictions for optimization can include, for example, available ships, vessels, or vehicles, their respective speeds, whether the optimized schedule should minimize cost or maximize profit. The computational optimization engine 102 can use the information received from the working schedule to generate an optimized schedule and update or modify the working schedule 104 with automated schedule adjustments. A user can issue a command through an interactive Gant interface 106 to request schedule optimization by the computational optimization engine.

In the working schedule 104, tasks could be developed completely manually, or some specific tasks could be added and fixed or locked in the schedule and the computational optimization engine 102 could be used to automatically add remaining tasks needed to optimize some business instance for the routing, scheduling and inventory management problem while best satisfying all constraints, or as many as possible. By way of example, once a user manually fixes one or more tasks, those fixed tasks become additional constraints for the computational optimization engine 102 to schedule around in generating the remainder of the schedule.

The computational optimization engine 102 could also be used to completely generate and add all tasks in order to optimize some business instance while best satisfying all constraints, or as many as possible. A user of the interactive Gantt interface 106 could call the computational optimization engine 102, embodying a model and solution system as those described in PCT/US2012/065310 or U.S. Ser. No. 11/802,616, which would generate a “grass roots” solution based on input data related to shipping requirements, contractual requirements, locations and storage capacity available, production and demand data, etc. Such a schedule of tasks would essentially be fully calculated by the optimization model(s) and solution methods embodied in the computational optimization engine 102. This would constitute of fully automated generation of a schedule of tasks with a goal of optimizing with respect to some objective function defined in the model(s).

Interactive Gantt Interface

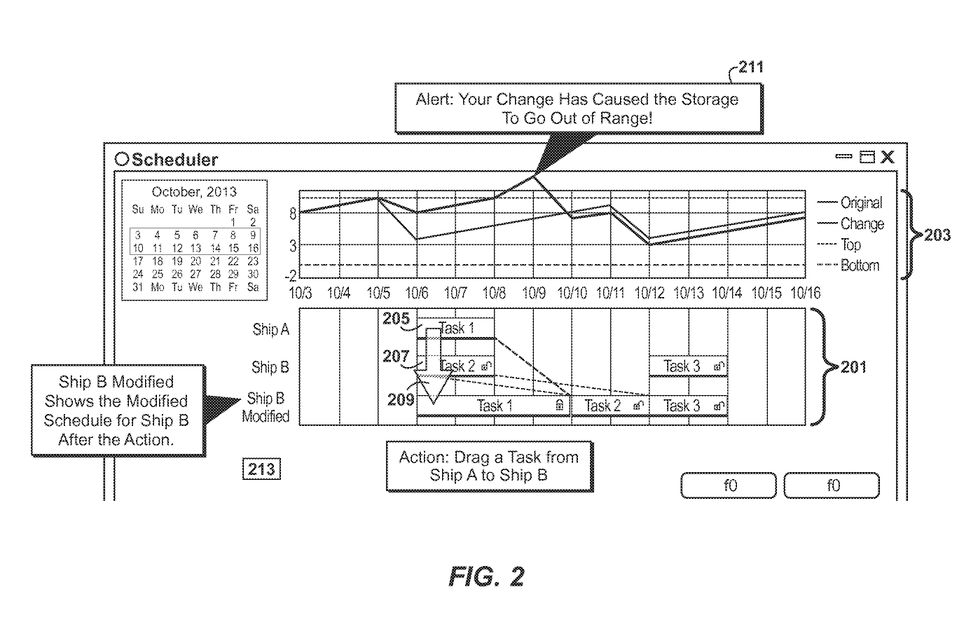

FIG. 2 illustrates an example of the interactive Gantt interface 106 (i.e., a graphical user interface). Particularly, FIG. 2 illustrates a static snapshot of the interactive Gantt interface 106. The interactive Gantt interface 106 includes a dynamic and intelligent Gantt chart 201, which visually depicts the working schedule 104, and an inventory chart 203.

The interactive Gantt, interface 106 allows a user to manipulate the working schedule 104, wherein changes to the working schedule can be immediately illustrated on the display of the working schedule in the interactive Gantt interface 106, and the inventory chart 203 then is automatically updated to reflect inventory level changes that result from corresponding changes to the working schedule.

The interactive Gantt interface 106 can provide an intelligent Gantt chart 201 such that a task to be scheduled could be selected from a set of options and placed on the chart and assigned to specific vehicles through a human interactive input device such as a mouse or touch screen (with or without a stylus). Such options are based on the task, and can include, but are not limited to, location traveled from/to, amount of material loaded/unloaded, waiting or idle time. These tasks could also be automatically generated via the computational optimization engine 102. The user would have the ability to move, drag or slide a task in its location on the Gantt chart to an earlier or later point in time, or move it from one vehicle to another. When moving the task between vehicles, various attributes of the task could automatically be adjusted based on any dependencies on the attributes of the vehicle. For example, if the task involves a voyage or travel, and different vehicles have different speeds of travel, moving the task from one vehicle to another would cause the duration of the task to automatically adjust based on the speed of the vehicle to which it is assigned. As a user slides or moves tasks within the chart, other tasks would potentially automatically be repositioned to avoid overlaps. However, ship speed is not the only attribute that distinguishes ships. Other possible attributes include, but are not limited to, ship cost structure, voyage fuel selection, and boil off rates. By reassigning a task to a different ship, metrics including but not limited to economics, volume delivered to customer, and timing of delivery may be affected. The rules by which this repositioning would occur can be controlled by the rules and calculations system 108.

Further, the interactive Gantt interface 106 can include a display of the projected inventory levels 203 based on the schedule in the Gantt chart 201. As the schedule in the Gantt chart 201 is adjusted, the inventory levels 203 can automatically be adjusted in real time in order to indicate to the user whether or not any inventory capacity limits would be violated.

While FIG. 2 provides inventory chart 203 as a metric to evaluate the working schedule, inventory is not the only metric that can be displayed as part of the interactive Gantt chart 106. The interactive Gantt chart 106 can provide live metrics and feedback about schedule feasibility, profit, inventory, economic indicators, quantity delivered to a customer and how that compares against contractual delivery obligations, resource utilization, ratability of delivery, and other metrics including resource utilization. This is not an exhaustive list, and other metrics can be used with the present technological advancement. These metrics can be used to evaluate what-if scenarios and quickly analyze their impact to the business. While FIG. 2 shows the use of one metric (inventory), multiple metrics can be used together.

Arrow 209 illustrates that the interactive interface 106 enables a user to select Task 1 from Ship A and drag, slide or move it straight down to Ship B using a mouse, touch screen (with or without a stylus), or other input device. Ship B will take twice as long to complete Task 1, and the length of the rectangle that represents Task A will expand in a dynamic and animated manner to twice its original length to represent the total amount of time required for Ship B to complete Task A.

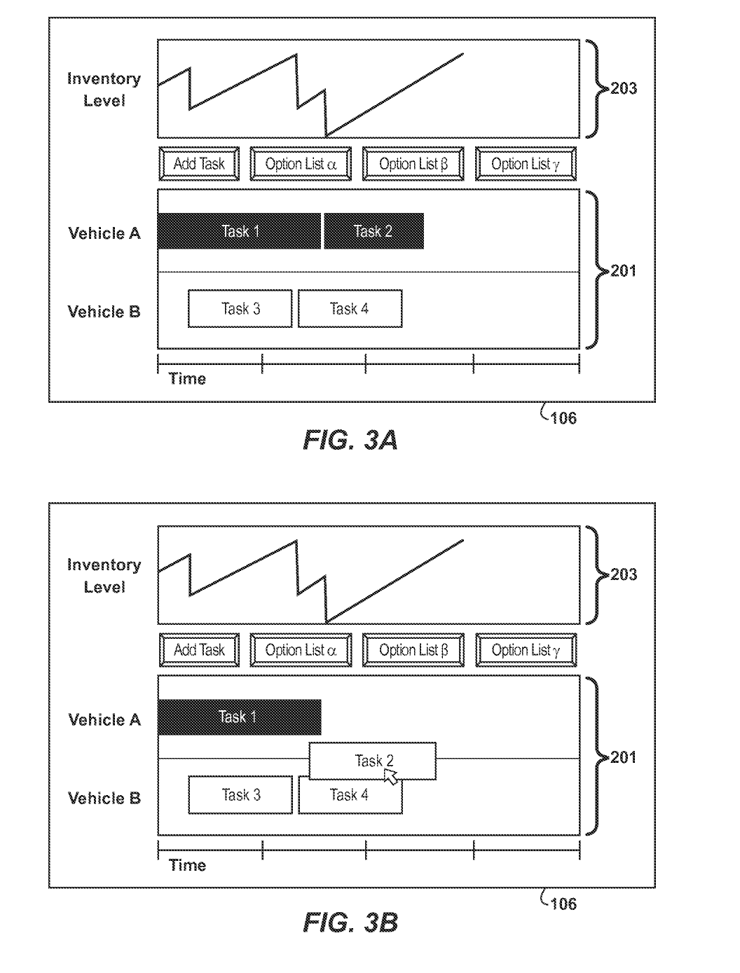

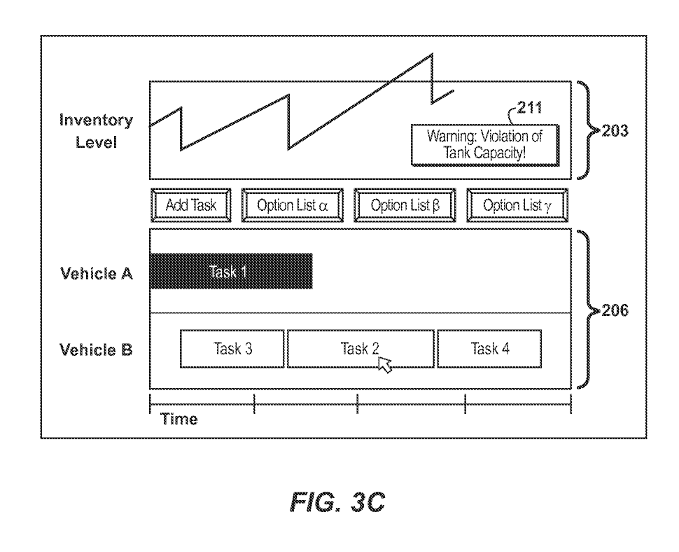

For illustration purposes, the original schedules for Ship A and Ship B remain visible in FIG. 2. An additional row was added to the schedule called “Ship B Modified” to illustrate how the changes propagate from the original schedule in the row “Ship B”. Further details of how the interactive Gantt chart is used for modifying a task will be discussed in the context of FIGS. 3A-3C.

In FIG. 2, for the intelligent Gantt chart 201, the Y-axis represents ships and the X-axis represents time. The tasks are defined as the time required for ship to load at a specific supply location, travel to another location to deliver the cargo, unload at that location, and return to another specific supply location. The length of the task bars may change as you slide them to adjust for different ship speeds, ship class, and ship capacity which affect travel time, load time and unload time. As a default, the tasks could be based on fully loaded ship at standard speed. However, for example, right clicking a task with a mouse could allow a user to change task details to allow for more complex deliveries, non-standard speed, partial loadings, etc. However, changes to task details can be judged against the rules, model constraints, and business logic established by the rules and calculations system 108. Important model constraints and business logic may include, but are not limited thereto, changes in cost, fuel consumption, and accounting for which tasks can be completed by which resources.

As a result of the manual manipulation of Task 1 to Ship B, the interactive Gantt interface will visually display an animated shifting of Task 2 to a later date, which allows Task 1 to be completed by Ship B. When the shifting is completed, the inventory chart 203 is updated to show the original and changed storage values.

While the interactive Gantt interface 106 is discussed with respect to an example where a task is reassigned, the interactive Gantt interface 106 can provide users with the ability add or delete resources/tasks from the schedule. When adding a task to an existing schedule, the user can select the task from a list in the user interface and assign it to a resource. Moreover, the present technological advancement can generate a working schedule from scratch.

Furthermore, the interactive Gantt interface can be used to change attribute of a voyage without necessarily changing the resource assigned to the voyage. For example, the vehicle or vessel can remain the same, while speed, cost structure, voyage fuel, route, heel, cargo size, customer and/or delivery location associated with that voyage can be changed. As discussed above, the vehicle/vessel routing and scheduling application shown in FIG. 1 can automatically adjust the working schedule based on changes to these attributes, in addition to changes in the resource (vehicle/vessel assignments).

Having Ship B complete Task A causes the tank storage volume (inventory level) illustrated in inventory chart 203 to go above the maximum, and an alert 211 pops up indicating an issue. While an alert for an inventory level is depicted, other alerts are possible. For example, if too many tasks are occurring simultaneously at the same berth or location, an alert might be given to the user. As depicted in FIG. 1, the rules and calculations system 108 analyzes changes to the schedule and can cause the interactive Gantt interface 106 to display alert 211. In FIG. 2, the alert is visual, but the alert could be visual and/or audible.

The interactive Gantt interface 106 can include a button 213 that, when activated by a user, will cause the computational optimization engine 102 to automatically adjust the schedule resulting from the manual change in order to achieve a new schedule with a goal of feasibility with respect to various constraints and rules. The rules and calculations system 108 and the computational optimization engine 102 can work together to generate a feasible schedule by making minor adjustments or a minimal set of adjustments to the schedule resulting from the manual change so the new schedule is closer to achieving feasibility without making substantial changes to the schedule from which it started.

FIGS. 3A, 3B, and 3C illustrate an example of an animation in the interactive Gantt interface regarding the moving, sliding, or dragging of a task in the interactive Gantt chart. FIG. 3A illustrates an initial view of the interactive interface 106, which includes an inventory chart 203 and the interactive Gantt chart 201. Inventory chart 203 depicts inventory levels for the current assignment of tasks (Tasks 1 and 2 assigned to Vehicle A and Tasks 3 and 4 assigned to Vehicle B).

If the user decides to reassign Task 2 to Vehicle B, the user can drag Task 2, using an input device or touch screen, towards the row for Vehicle B. This is illustrated in FIG. 3B. The size of the Task 2 rectangle changes as the Task 2 rectangle is moved toward the Vehicle B row. The size of the Task 2 rectangle is adjusted in a gradual manner proportional to expand to represent the increased amount of time it will take Vehicle B to complete Task 2. In this example, the Task 2 rectangle is enlarged, but situations are possible where the rectangle size could decrease or remain the same.

FIG. 3C illustrates an example where Task 2 is fully moved to the Vehicle B row. As a consequence, Task 4 is rescheduled to account for the modification to Task 2. In terms of the animation of the interface, Task 4 can be slid to its new position as Task 2 is slid into its new position. However, other ways depicting the rescheduling of Task 4 are possible and can be used with the present technological advancement.

The inventory chart 203 has also changed in FIG. 3C, to represent the changes in inventory levels that are caused by the reassignment of Task 2 to Vehicle B. In this example, the change in schedule as resulted in inventory levels exceeding there maximum level, which necessitated display of warning 211.

The present technological advancement is not limited to seafaring ships, as are used in the example shown in FIG. 2. The present technological advancement can be applied to tasks associated with delivering any type of material from one location to another. Moreover, tasks do not necessarily have to be associated with vessels or vehicles. On the contrary, a task may be associated with any resource that may be involved in completing a task (i.e., computer processing or equipment).

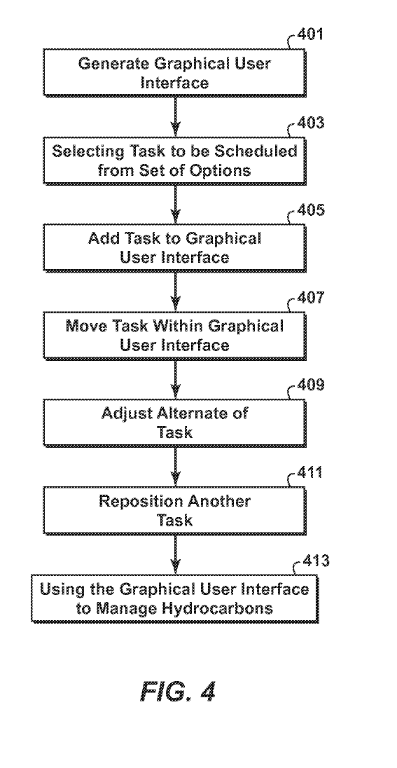

FIG. 4 illustrates an exemplary method of using the interactive Gantt interface. Step 401 includes generating a graphical user interface including an interactive Gantt chart 201. Step 403 includes selecting a task to be scheduled from a set of options provided through the graphical user interface. Step 405 includes adding a visual representation of the task to the interactive Gantt chart 201 and assigning the task to a first vehicle or vessel. Step 407 includes moving, on the interactive Gantt chart, the visual representation of the task from a first location in the interactive Gantt chart to a second location in the interactive Gantt chart, wherein the moving is in response to user interaction with a computer input device. The moving can include moving the visual representation to an earlier point in time or a later point in time on the interactive Gantt chart. The moving can include moving the visual representation from the first vehicle or ship assignment to a second vehicle or vessel assignment. Step 409 includes automatically adjusting an attribute of the visual representation of the task based on an attribute of the second vehicle or vessel assignment. The automatically adjusting can include generating an animation of the size of the visual representation changing as the task is moved on the Gantt chart to the second vehicle or vessel assignment. In step 401, in response to the moving, repositioning another task on the interactive Gantt chart to avoid an overlap between the task and the another task. In step 413, the interactive Gantt chart 201 is used to manage hydrocarbons.

The steps in FIG. 4 do not necessarily need to be performed in the order recited, and steps could be performed simultaneously.

Rules and Calculations System

For example, if the user moved a task to a time where another task was already located in the schedule for some vehicle, the rules and calculations system 108 would determine how to reposition the other task, and potentially other affected tasks, to comply with the moved task. The interactive Gantt interface 106 could animate the movement of the affected tasks on the intelligent Gantt chart 201. The rules and calculations system 108 would also give the user alerts or warnings after every change regarding any additional or side constraints that are violated.

In the example provided in FIG. 2, when Task 1 is reassigned to Ship B, Task 1 then conflicts with Task 2 (i.e., Ship B cannot complete Tasks A and B simultaneously). Such a conflict can be determined by the analysis of schedule changes by rules and calculations system 108, which can prompt a further change to the working schedule 104 in order to resolve such conflicts. For example, if the user moved a task to a time where another task was already located in the schedule for some vehicle (i.e., the situation illustrated in FIG. 2), the rules and calculations system 108 would determine how to reposition that task (Task B in FIG. 2), and potentially other affected tasks to comply with the moved task.

The interactive Gantt interface 106 can receive updated warnings and alerts for display on a monitor from rules and calculations system 108. Rule and calculations system 108 can analyze changes to the working schedule 104 and can create warning and alerts, displayable to a user, if a change to the working schedule 104 will violate a pre-established rule. For example, if a change to the schedule would create insufficient inventory to fill an order, an alert/warning could be generated and displayed to the user through the interactive Gantt interface 106, which would prompt the user to take corrective action. For example, if too many tasks are occurring simultaneously at the same berth or location, an alert might be given to the user to that effect. Advantageously, a user making manual adjustments to the working schedule 104 could be alerted to possible problems in the working schedule in almost real-time.

Warnings provided by the user interface are not necessarily limited to inventory constrain violations. Warning can be initiated by other metrics or indicators violating specified constraints.

### Examples

The following example is provided to explain the interactive and intelligent functionality of the interactive Gantt interface 106. Reference number 205 in FIG. 2 illustrates that an initial working schedule 104 has Ship A assigned to Task 1 and reference number 207 illustrates that Ship B is assigned to Task 2. As with conventional Gantt charts, the length of the rectangles associated with Task 1 and Task 2 represent the amount of time required to complete the respective task. Blank space between tasks represents waiting or idle time at a supply location. A timeline is depicted between elements 201 and 203.

The intelligent Gantt chart 202 can be manipulated by a user in order to change the working schedule. For example, the user can change working schedule 104 by reassigning Task 1 from Ship A to Ship B. Starting from a complete working schedule 104, the user could move some tasks and possibly add or delete some others, and then use the computational optimization engine 102 to re-optimize the business instance after setting some restrictions or limits on what extent tasks may be moved or re-assigned. As illustrated in FIG. 1, such a manual adjustment to the schedule is communicated by the interactive Gantt interface 106 to the working schedule 104.

By way of example, let delivery from port L1 by Ship A to port L2 be reassigned to Ship B. Given the knowledge that Ship B travels at a slower speed than Ship A, delivery takes longer. This could be further delayed if the unloading times are different at port L1 vs. port L2. In the case of shipping LNG, longer delivery time causes more losses of LNG due to boiloff during the voyage. Thus, less product is delivered to port L2, which reduces revenue generated. In this example, suppose that contractual obligations for quantity delivered may be violated due to this increase loss of LNG in the resulting schedule. Then future deliveries to port L2 may need to be rescheduled because of contractual obligations. The point of the example is to illustrate that changing schedules manually can cause cascading effects down the line. The rules and calculations system 108 can warn or alert the user of these impacts on the schedule if constraints are violated, or perhaps close to being violated. The computational optimization engine can be used, via a command from the interactive Gantt interface 106, to allow the system to use small optimization model(s) to massage or adjust the schedule to eliminate violations of constraints.

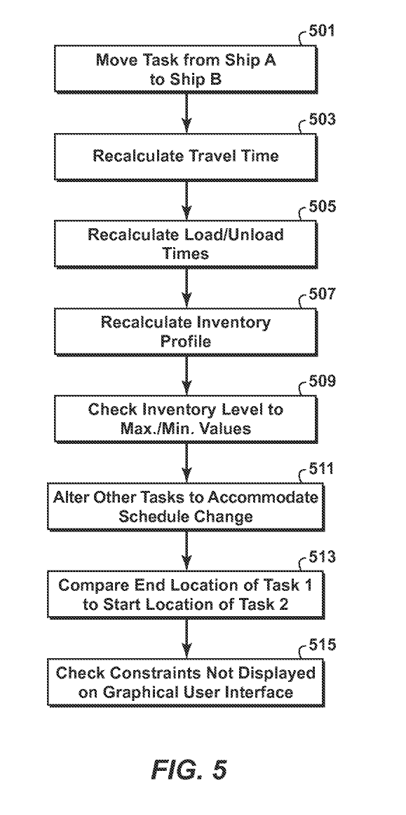

By way of explanation, exemplary calculations that the rules and calculations system 108 can perform in order for the actions described in FIG. 2 to be implemented are discussed below. The rules and calculations system 108, in conjunction with processing circuitry, can execute the following method, depicted in FIG. 5. In step 501, Task 1 is dragged from Ship A to Ship B on the intelligent Gantt chart 201.

In step 503, a length of time for travel time periods in the task are recalculated if, for example, the nautical speed of ship B is different from Ship A in the data set.

In step 505, load and unload times for Task 1 are recalculated if, for example, the maximum flow rates of material for Ship B are different than Ship A. Further, if, for example, the size of Ship B is different than Ship A in terms of holding capacity, the amount loaded/unloaded onto the ship would be set to the new maximum. Based on a new loading or unloading rate and the new amount to load and unload, the times for loading and unloading can be recalculated for Task 1.

In step 507, due to the change in timings of the actions within Task 1, and also the possible difference in the amount of material loaded and unloaded when changing from Ship A to Ship B, the inventory profile displayed above the Gantt chart (see FIG. 2) could also be recalculated in consideration of how the timing of loading and unloading at the inventory location effect inventor levels. These changes could be relative to the starting time of Task 1 for Ship B.

In step 509, for this new inventory profile, a calculation could be performed to check if any inventory levels go above or below any minimum or maximum values for that location. If either of those occurs, then some kind of visual and/or auditory alert would be given to the user in the interactive Gantt interface 106.

In step 511, other tasks could be shifted to accommodate the change in schedule. Since Ship B had a task planned to begin in the time period Task 1 was placed, and there are subsequent tasks for Ship B, Task 2 would be pushed forward in time to start after Task 1 completes, and Task 3 would move forward to start after the new completion time for Task 3. The basic assumption would be that for the same ship, new tasks cannot overlap in time, i.e. a ship can only perform one task at any given time.

In step 513, the end location of Task 1 could be compared to the starting location for Task 2. If these two locations are not the same, Task 1 could not be permitted to be moved to that time period for Ship B. Some kind of visual and/or auditory alert would be given to the user in the interactive Gantt interface 106;

In step 515, constraints and rules for the scheduling application that are not displayed visually in the interface would also be checked. For example, due to the change in timing for ships arriving and departing various locations caused by the change of the timing of tasks, a check could be performed to see that the number of ships unloading or loading at a particular berth or port at a particular time is not exceeded. If this limit is exceeded, a visual and/or auditory alert would be given to the user in the interactive Gantt interface 106. Other types of constraints that might be checked could include, but are not limited to: contractual requirements for delivery of material to a particular location or entity within a particular period of time, whether the Task 1 can be performed by Ship B due to restrictions at the location, supplier, delivery receiver, etc.

The above example is specific to the case of ship scheduling and inventory management. One skilled in the art could extrapolate the above to other types of scheduling problems, and apply the present technological advancement in which the length of time for a task can be automatically adjusted based on the vehicle/vessel/processing unit (i.e., resource) for which it is assigned. Also, the steps in FIG. 5 do not necessarily need to be performed in the order recited, and steps could be performed simultaneously. Further, a user of the technology could also be allowed to manually adjust time lengths and loading/unloading amounts.

The present technological advancement can provide for the locking of particular pieces of information in the schedule in place. A user of the interactive Gantt interface 106 could take an existing schedule of tasks, and fix or lock some portion of it to be unchangeable by the computational optimization engine 106, and then allow the computational engine to only work to modify that portion that can be changed in order to improve the schedule of tasks subject to some objective function defined in the model(s). Thus, when optimization is run by the computational optimization engine 102 in order to achieve feasibility, the system will know that the user does not want changes made to particular things in the schedule. For example, Task 1 is shown with a lock to indicate that this task would stay positioned where it was placed if an optimization model is run by the computational optimization engine 102. The locking of task allows for the user to examine different what-if scenarios by controlling which tasks are locked (can't be changed by the optimization model) and unlocked (can be changed by the optimization model). Use of the lock/unlock feature provides the user with the ability to examine changes to the schedule, resources, and contracts and to reliably and quickly determine the impact to the business.

If all constraints and rules cannot be satisfied by the model(s) and solution methods, the computational engine could be configured to output a schedule of tasks that best approaches achieving feasibility. In that case, various alerts would be displayed to the user in the interface to indicate which constraints or rules are violated.

The present technological advancement can also be used in the following scenarios and allow for certain questions to be answered: can we perform this schedule change without impacting other deliveries; If an additional delivery is initially infeasible, what changes would have to be made to the existing schedule to allow us to make this additional delivery feasible; What impact do these changes to the schedule have one annual or quarterly profit; What impact do these changes have on our customers and our contracts; The company is considering discontinuing usage of a particular shipping route. The scheduling interface could be updated to replace the old route with a new route to determine impact on the current schedule; A customer asks for an additional delivery. The interactive Gantt interface 106 can be used to add a new delivery, assign it to a resource, and a starting time; and A resource needs to be scheduled for immediate maintenance. The interactive Gantt interface 106 can be used to remove the resource and open all tasks assigned to that resource to be rescheduled to new resources (either manually or by the rules and calculation systems 108 and/or the computational optimization engine).

Computer System

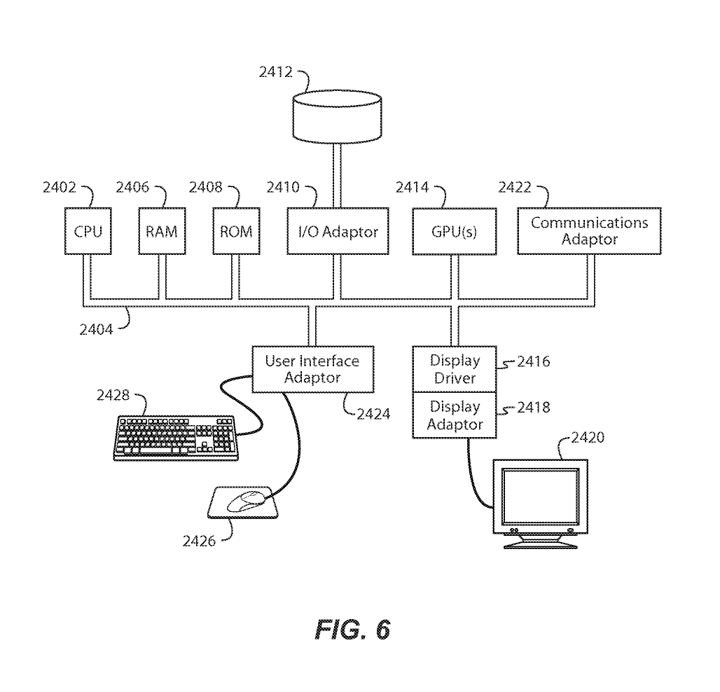

FIG. 6 is a block diagram of a computer system 2400 that can be used to execute any of the above functionality associated with the interactive Gantt interface 106 (including components illustrated in FIG. 2), rules and calculations system 108, computational optimization engine 102, and working schedule 104. A central processing unit (CPU) 2402 is coupled to system bus 2404. The CPU 2402 may be any general-purpose CPU, although other types of architectures of CPU 2402, (or other components of exemplary system 2100) may be used as long as CPU 2402 (and other components of system 2400) supports the operations as described herein. Those of ordinary skill in the art will appreciate that, while only a single CPU 2402 is shown in FIG. 6, additional CPUs may be present. Moreover, the computer system 2400 may comprise a networked, multi-processor computer system that may include a hybrid parallel CPU/GPU system. The CPU 402 may execute the various logical instructions according to various teachings disclosed herein. For example, the CPU 2402 may execute machine-level instructions for performing processing according to the operational flow described.

The computer system 2400 may also include computer components such as non-transitory, computer-readable media. Examples of computer-readable media include a random access memory (RAM) 2406, which may be SRAM, DRAM, SDRAM, or the like. The computer system 2400 may also include additional non-transitory, computer-readable media such as a read-only memory (ROM) 2408, which may be PROM, EPROM, EEPROM, or the like. RAM 2406 and ROM 2408 hold user and system data and programs, as is known in the art. The computer system 2400 may also include an input/output (I/O) adapter 2410, a communications adapter 2422, a user interface adapter 2424, and a display adapter 2418.

The I/O adapter 2410 may connect additional non-transitory, computer-readable media such as a storage device(s) 2412, including, for example, a hard drive, a compact disc (CD) drive, a floppy disk drive, a tape drive, and the like to computer system 2400. The storage device(s) may be used when RAM 2406 is insufficient for the memory requirements associated with storing data for operations of the present techniques. The data storage of the computer system 2400 may be used for storing information and/or other data used or generated as disclosed herein. For example, storage device(s) 2412 may be used to store configuration information or additional plug-ins in accordance with the present techniques. Further, user interface adapter 2424 couples user input devices, such as a keyboard 2428, a pointing device 2426 and/or output devices to the computer system 400. The display adapter 2418 is driven by the CPU 2402 to control the display on a display device 2420 to, for example, present information to the user regarding available plug-ins.

The architecture of system 2400 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” refers to any of a hardware processor (such as those found in the hardware devices noted above), ASICs, and VLSI circuits. Input data to the computer system 2400 may include various plug-ins and library files. Input data may additionally include configuration information.

The present techniques may be susceptible to various modifications and alternative forms, and the examples discussed above have been shown only by way of example. However, the present techniques are not intended to be limited to the particular examples disclosed herein. Indeed, the present techniques include all alternatives, modifications, and equivalents falling within the spirit and scope of the appended claims.

What is claimed is:

1. A system, comprising:
a memory that stores computer executable instructions; and
processing circuitry that executes the instructions in order to,
generate a graphical user interface, which includes an intelligent Gantt chart that displays a working schedule of a task assigned to a resource,
receive a command to change the working schedule,
integrate the change into the working schedule, and
update and display a performance metric based on the change.

2. The system of claim 1, wherein
the command reassigns the task to a different resource, and
the processing circuitry executes the instructions to adjust an attribute of the task as applied to the different resource, and integrate the task assigned to the different resource into the working schedule.

3. The system of claim 1, wherein
the command adjusts an attribute of the task, and
the processing circuitry executes the instructions to adjust the attribute of the task, and integrate the adjusted task into the working schedule, while the task remains assigned to the resource.

4. The system of claim 3, wherein the attribute of the task is at least one of speed, cost structure, voyage fuel, route, heel, cargo size, customer, or delivery location.

5. The system of claim 2, wherein
the attribute is a length of time to complete the task, which is adjusted by the processing circuitry based on a difference in time for the different resource to complete the task relative to an amount of time for the resource to complete the task,
the intelligent Gantt chart includes a visual representation of the task, a size of the visual representation of the task reflecting an amount of time needed to complete the task by the resource,
the command represents movement of the representation of the task from a first location in the Gantt chart, associated with the resource, to a second location in the Gantt chart associated with the different resource, and
the processing circuitry animates the movement of the visual representation of the task from the first location to the second location while altering the size of the visual representation of the task to reflect an amount of time needed to complete the task by the different resource.

6. The system of claim 5, wherein
the second location in the intelligent Gantt chart is a time in the schedule where a second task is already scheduled to be completed by the different resource,
the processing circuitry determines a new position for the second task, within the intelligent Gantt chart, to comply with the reassignment of the task to the different resource; and
the processing circuitry visually depicts movement of a visual representation of the second task, within the intelligent Gantt chart, to the new position.

7. The system of claim 5, wherein the different resource is a vessel or a vehicle.

8. The system of claim 2, wherein the processing circuitry is configured to optimize the working schedule.

9. The system of claim 8, wherein
the intelligent Gantt chart includes a schedule with a plurality of different tasks distributed amongst a plurality of different resources, and
the processing circuitry is configured to optimize the working schedule while locking at least one of the tasks so that optimization does not alter attributes of the at least one of the tasks.

10. The system of claim 8, wherein
the processing circuitry is configured to analyze the change to the working schedule according to a pre-established rule, and
the processing circuitry is configured to optimize the working schedule, including the change, that best satisfies the pre-established rule.

11. The system of claim 10, wherein the processing circuitry is configured to cause the graphical user interface to display a warning in response to a determination by the processing circuitry that the change to the working schedule violates the pre-established rule.

12. The system of claim 11, wherein the processing circuitry is configured to cause the graphical user interface to display the warning in response to at least one of too many tasks occurring simultaneously, or projected inventory levels resulting from the change to the working schedule violate an inventory capacity limit.

13. A method, comprising:
generating a graphical user interface including an interactive Gantt chart;
selecting a task to be scheduled from a set of options provided through the graphical user interface;
adding a visual representation of the task to the interactive Gantt chart and assigning the task to a first vehicle or vessel; and
moving, on the interactive Gantt chart, the visual representation of the task from a first location in the interactive Gantt chart to a second location in the interactive Gantt chart, wherein the moving is in response to user interaction with a computer input device.

14. The method of claim 13, wherein the moving includes moving the visual representation to an earlier point in time or a later point in time on the interactive Gantt chart.

15. The method of claim 13, wherein the moving includes moving the visual representation from a position assigned to the first vehicle or ship to a position assigned to a second vehicle or vessel.

16. The method of claim 15, further comprising:
automatically adjusting an attribute of the visual representation of the task based on an attribute of the second vehicle or vessel.

17. The method of claim 16, wherein the visual representation of the task has a size proportional to a duration to complete the task, and the automatically adjusting includes generating an animation of the size of the visual representation changing as the task is moved on the Gantt chart to the position assigned to the second vehicle or vessel.

18. The method of claim 15, wherein the attribute of the second vehicle or vessel assignment is a speed.

19. The method of claim 13, further comprising:
in response to the moving, repositioning a visual representation of another task on the interactive Gantt chart to avoid an overlap between the task and the another task.

20. The method of claim 14, wherein the computer input device is a mouse or a touchscreen.

21. The method of claim 13, further comprising:
using the interactive Gantt chart to manage hydrocarbons.

22. The method of claim 16, further comprising:
determining a travel time for the task to be completed by the second vehicle or vessel, and
determining load and unload times for the task based on reassignment to the second vehicle or vessel, wherein
the automatically adjusting the attribute of the visual representation of the task is based on the travel time for the task to be completed by the second vehicle or vessel, and the load and unload time for the task with the second vehicle or vessel.

23. The method of claim 22, further comprising:
determining an updated inventory profile resulting from the task being completed by the second vehicle or vessel; and
determining whether an inventory level goes above or below minimum and maximum values at location the second vehicle or vessel is scheduled to load or unload inventory at.

24. A non-transitory computer readable medium encoded with instructions, which when executed by a computer causes the computer to execute a method comprising:
generating a graphical user interface including an interactive Gantt chart;
selecting a task to be scheduled from a set of options provided through the graphical user interface;
adding a visual representation of the task to the interactive Gantt chart and assigning the task to a first vehicle or vessel; and
moving, on the interactive Gantt chart, the visual representation of the task from a first location in the interactive Gantt chart to a second location in the interactive Gantt chart, wherein the moving is in response to user interaction with a computer input device.
